(19) United States
(12) Patent Application Publication
(10) Pub. No.: US 2015/0336451 A1
(43) Pub. Date: Nov. 26, 2015

(54) Top Cover Support Structure of Open-Top Rear Cargo Bed of Truck

(71) Applicant: Yi Ting Enterprise Co., Ltd., New Taipei City (TW)

(72) Inventor: Ming-Te Liao, New Taipei City (TW)

(73) Assignee: Yi Ting Enterprise Co., Ltd., New Taipei City (TW)

(21) Appl. No.: 14/284,396

(22) Filed: May 22, 2014

(51) Int. Cl. B60J 7/16

(52) U.S. Cl. CPC B60J 7/1621

(57) ABSTRACT

A top cover support structure is connected between an open-top rear cargo bed of a truck and a top cover to serve as a support structure for opening and closing the cover. The transmission linkage includes a fixed bar mounted to the open-top rear cargo bed, a movable bar mounted to the top cover, and first and the second swing bars each having ends pivotally connected to the fixed bar and the movable bar. A bottom bracket is mounted to a side panel of the open-top rear cargo bed to receive the fixed bar of the transmission linkage to attach thereto. A top cover retention seat is mounted to the top cover to receive the movable bar to attach thereto. A hydraulic (pneumatic) cylinder is pivotally connected to the open-top rear cargo bed and the top cover.

### (a) TECHNICAL FIELD OF THE INVENTION

The present invention generally relates to an improved top cover structure of an open-top rear cargo bed of a truck, and more particularly to a structure that is arranged between an open-top cargo bed and a top cover of a pickup truck to provide stable and smooth operations of opening and closing the top cover and also provided a better loading effect of the entire structure.

### (b) DESCRIPTION OF THE PRIOR ART

Automobile is a convenient transportation device. Particularly, a pickup truck, besides being capable of carrying passengers, is also provided with a rear cargo bed for loading and carrying cargos. It is common a closable top cover is provided to protect the cargos loaded in the bed from getting wet by rainwater or being stolen and also to improve overall aesthetics of the automobile. The top cover is hinged, at opposite sides thereof, to the rear cargo bed. In addition, the top cover is coupled, at two sides thereof, to side panels of the cargo bed with hydraulic (pneumatic) cylinders to support the top cover when the top cover is opened. However, the top cover is of quite a size and is only supported by two pivots constituted by the two hinges at two sides of the cargo bed for the rotary motion thereof. Thus, the top cover is susceptible to sideway sway and gets unstable. This leads to easy damage of the parts and may eventually cause concerns of safety. Apparently, improvement is necessary.

Further, the rear cargo beds are generally structured differently for automobile of different modes and brands. Support assemblies used in such different cargo beds are often different. This leads to poor adoptability of the support assemblies to different automobiles and additionally, installation of the support assembly is also difficult, requiring skilled technicians with proper tools to have the installation correctly handled. This is certainly inconvenient to the general users. The imperfect structural designs of the top cover support assemblies often make it difficult for the technician to efficiently and effectively mount the top cover support assemblies to automobiles of different modes and brands and also cause the above discussed issued of adoptability.

In view of these problems, U.S. patent application Ser. No. 11/713,095, “Upper Cover Support Structure for an Automobile Rear Loading Platform”, filed by the present applicant discloses an upper cover support assembly. The present invention is made for the purposes of providing an improved top cover structure of an open-top rear cargo bed of a truck that is more stable and safer, allowing for more convenient installation and also allowing most of the components/parts to be commonly applicable to automobiles of various modes/brands.

### SUMMARY OF THE INVENTION

An object of the present invention is to provide an improved top cover support structure of an open-top rear cargo bed of a truck, which have improved structural and loading characteristics in the entirety thereof so that opening and closing the top cover can proceed in a more stable, more smooth, and safer manner and an effect of improved supporting and cushioning can be achieved.

Another object of the present invention is to provide an improved top cover support structure of an open-top rear cargo bed of a truck, which is applicable to installation of rear cargo bed top covers of trucks of various modes/brands and which adopts a modularized design, making the assembling easier and faster and achieving reduction of manufacturing cost through wide adoptability of the components thereof in automobiles of various modes and brands.

To achieve the above objects, the present invention provides an improved top cover support structure of a rear cargo bed of a truck, which comprises a transmission linkage connected between the open-top rear cargo bed of the truck and the top cover at an opening/closing portion thereof, a bottom bracket mounted to a top edge of an inside surface of each of two side panels of the open-top rear cargo bed, a top cover retention member mounted to a bottom of the top cover of the open-top rear cargo bed at the opening/closing portion thereof, and a hydraulic (pneumatic) cylinder pivotally connected to the open-top rear cargo bed and the top cover at two sides of the lifting portion thereof. The transmission linkage comprises a fixed bar mounted to the bottom bracket, a movable bar mounted to the top cover retention seat of the open-top rear cargo bed, and a first swing bar and a second swing bar pivotally connected between the fixed bar and the movable bar. In a preferred embodiment, two sets of the transmission linkage, the bottom bracket, the top cover retention seat, and the hydraulic (pneumatic) cylinder are provided between the open-top rear cargo bed and the top cover and respectively set at opposite sides of the open-top rear cargo bed to make lifting and lowering of the top cover stable.

As such, when the top cover is lifted upwards, the movable bar is caused to move so that with the fixed bar serving a fixed side, the first swing bar and the second swing bar are driven to move, whereby an angular difference between the two swing bars can be used to guide the top cover to lift upward in a stable and smooth manner.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an example where the present invention is mounted to a rear cargo bed of a truck.

FIG. 2 is an exploded view of the present invention.

FIG. 2a is an exploded view of a transmission linkage of the present invention.

FIG. 2b is a perspective view illustrating an operation of the transmission linkage of the present invention.

FIG. 3 is a perspective view illustrating installation of a hydraulic (pneumatic) cylinder of the present invention.

FIG. 4 is a perspective view showing an opening operation of the present invention.

FIG. 5 is a perspective view showing a closing operation of the present invention.

FIG. 6 is a side elevational view of the present invention after a top cover has been opened.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

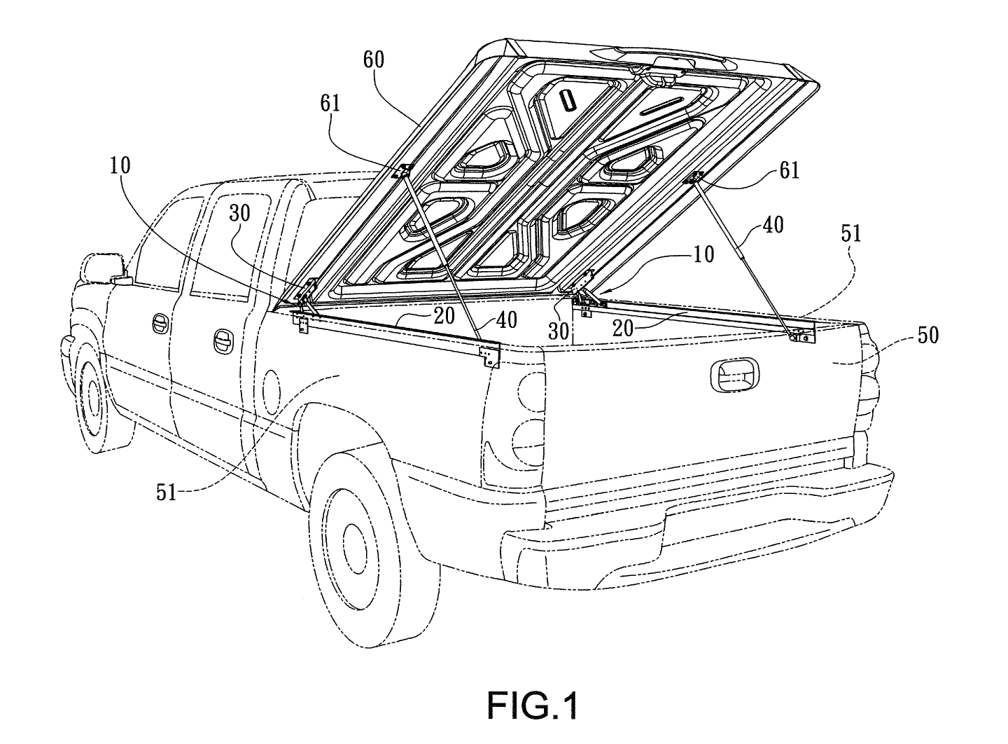

Referring to FIGS. 1-3, the present invention provides an improved top cover support structure of a rear cargo bed of a truck, which comprises: a transmission linkage 10, a bottom bracket 20, a top cover retention seat 30, and a hydraulic (pneumatic) cylinder 40, which is mounted between an open-top rear cargo bed 50 of a truck and a top cover 60 at two sides of the truck in order to provide an effect of opening and closing and supporting weight of the top cover 60 and also provide a cushioning effect in lowering the top cover. In a preferred embodiment, two sets of the transmission linkage 10, the bottom bracket 20, the top cover retention seat 30, and the hydraulic (pneumatic) cylinder 40 are provided between the open-top rear cargo bed and the top cover and respectively mounted to the two sides of the open-top rear cargo bed to make lifting and lowering of the top cover stable.

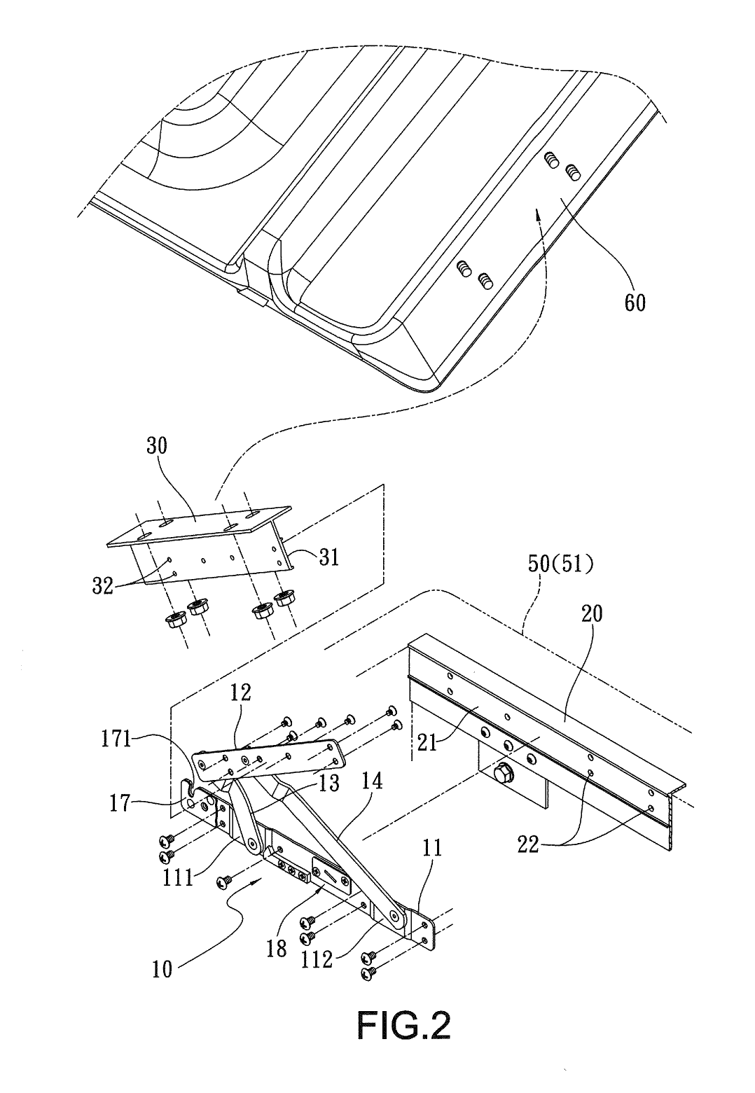

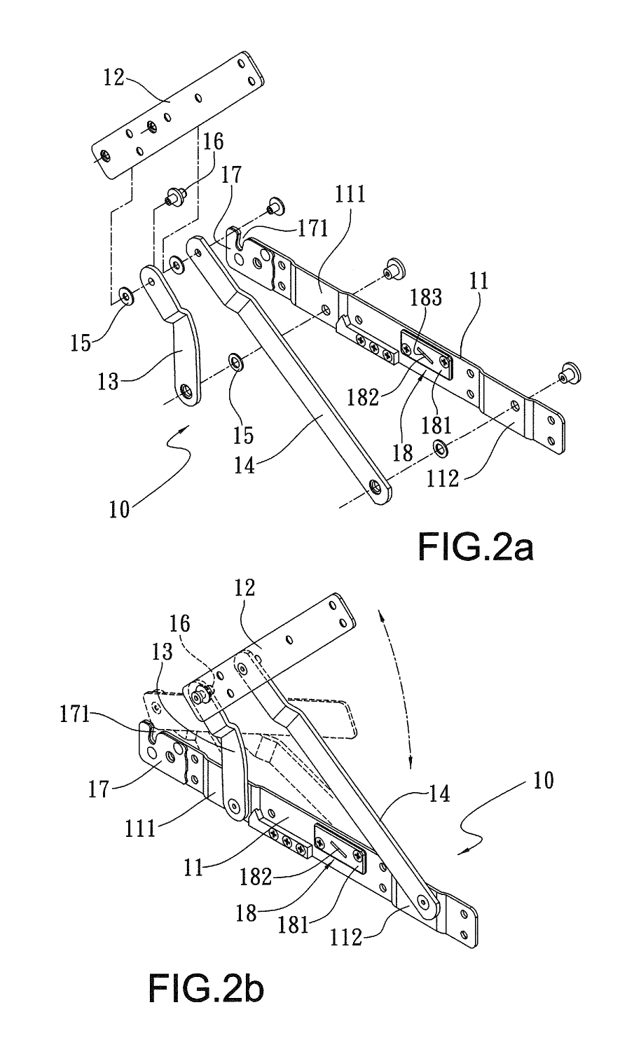

The transmission linkage 10 is connected between the open-top rear cargo bed 50 and the cargo bed top cover 60 to function as a supporting structure (as shown in FIGS. 2a and 2b) for opening and closing of the top coven Such a structure comprises a fixed bar 11, a movable bar 12, and a first swing bar 13 and a second swing bar 14 each having two ends respectively and pivotally connected to the fixed bar 11 and the movable bar 12. In the preferred embodiment shown in the drawings, a washer 15 is arranged to line at each pivotal joint and is riveted by a rivet in a rotatable manner so as to reduce the friction between the bars. The fixed bar 11 is formed with a first protrusion section 111 and a second protrusion section 112 for respectively and pivotally coupling with the first swing bar 13 and the second swing bar 14. Further, a positioning peg 16 is provided at the pivotal joint between the first swing bar 13 and the movable bar 12 and a limiting section 17 is provided at an end of the fixed bar 11 that is adjacent to the first protrusion section 111. The limiting section 17 comprises a notch 171 defined therein for receiving and positioning the positioning peg 16. The first swing bar 13 is fastened to the fixed bar 11 by a fastener. A sliding section 18 is arranged on the fixed bar at a location adjacent to the second protrusion section 112. The sliding section 18 is composed of a seat 181 and a roller 182. The seat 181 comprises a slot 183 formed therein with the roller 182 being received and retained in the slot 18 and is fastened by fasteners to a surface of the fixed bar 11. As such, when the transmission linkage 10 is set in operation, the first protrusion section 111, the second protrusion section 112, and the sliding section 18 provide assistance to achieve improved load carrying capability and operation smoothness.

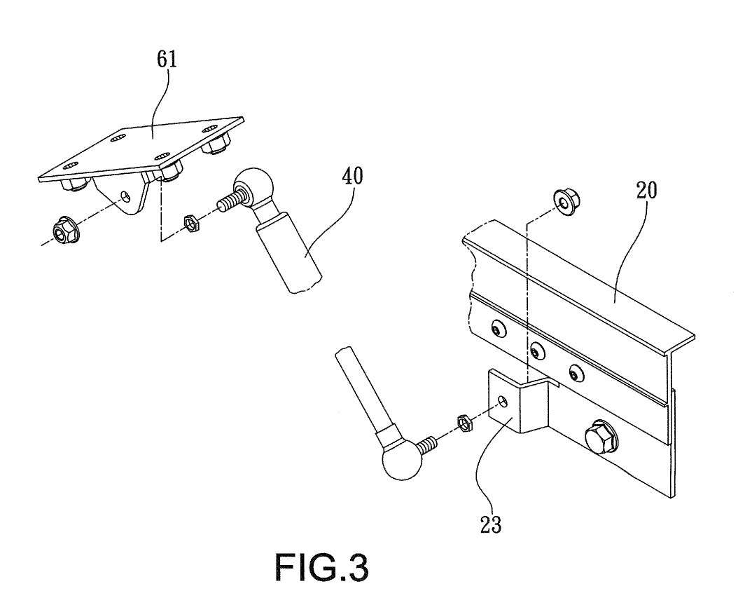

The bottom bracket 20 is mounted to a top edge of an inside surface of each of the two side panels 51 of the truck cargo bed 50 to receive the transmission linkage 10 to assemble therewith and has an assembling surface in which an elongate recess 21 is formed. The recess 21 comprises a plurality of fastening holes 22 formed in a front end section thereof to receive fasteners attached thereto to fix the fixed bar 11 of the transmission linkage 10 thereto. The bottom bracket 20 comprises a bearing plate 23 (see FIG. 3) formed on a rear end section thereof.

The top cover retention seat 30 is fastened by screws to each of two sides of a front end portion of a bottom surface of the top cover 60 to receive the transmission linkage 10 to assemble therewith and has an assembling surface comprising a recess 31 and a plurality of fastening holes 32 formed therein, whereby fasteners are used to fix the movable bar 12 of the transmission linkage 10 thereto.

The hydraulic (pneumatic) cylinder 40 has an end pivotally connected to the bearing plate 23 of the bottom bracket 20 and an opposite end pivotally connected by a pivotal joint seat 61 to a predetermined position of the top cover 60 (see FIGS. 1 and 3).

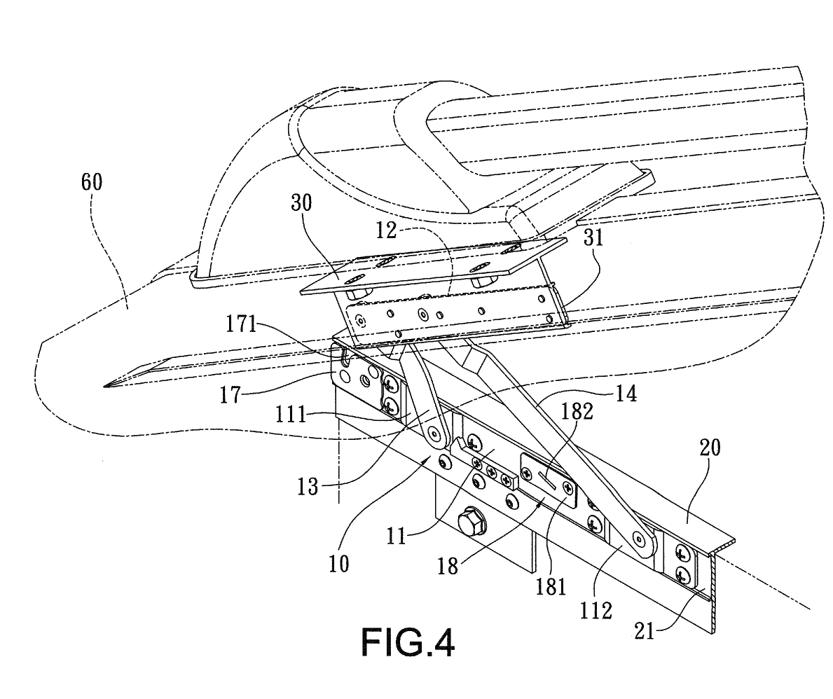

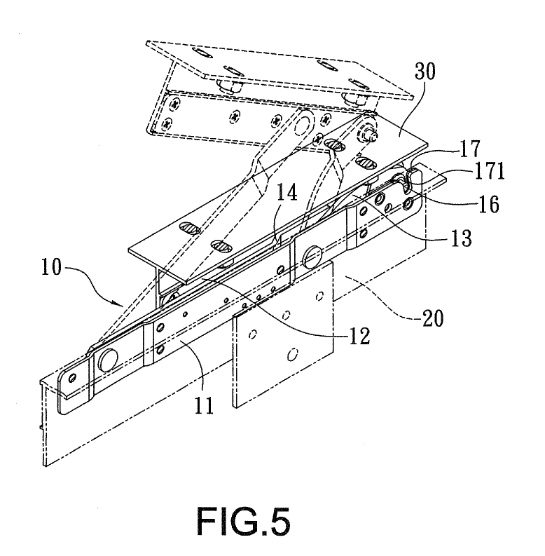

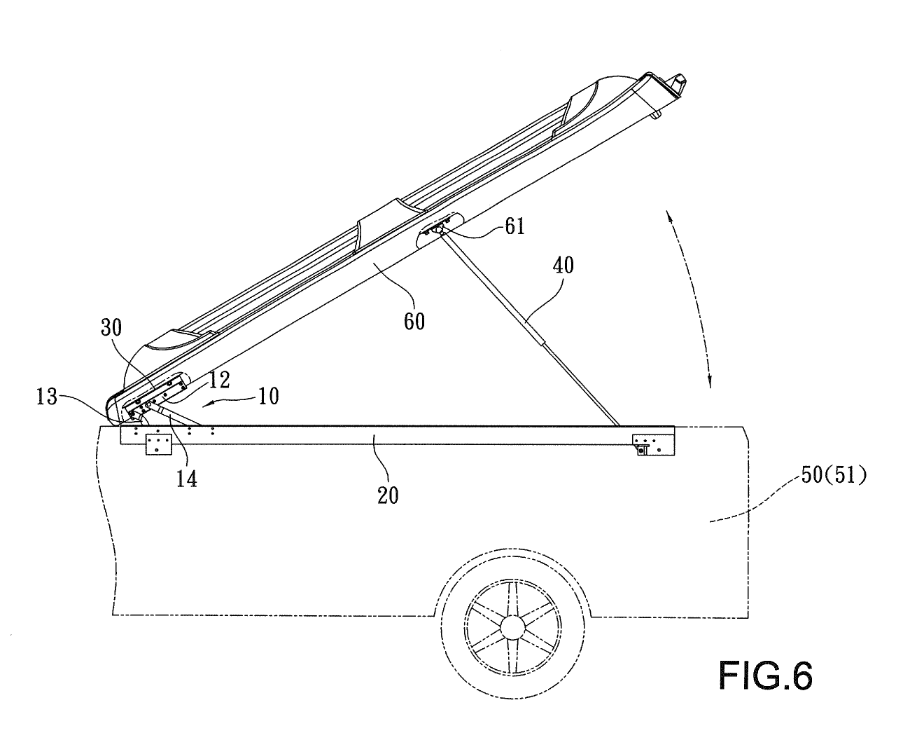

Referring to FIGS. 1 and 4-6, in the embodiment illustrated, two transmission linkages 10, two bottom brackets 20, two top cover retention seats 30, and two hydraulic (pneumatic) cylinders 40 are provided between the top cover 60 and the open-top rear cargo bed 50 at left and right sides in a symmetric manner. When the top cover 60 is lifted upward from a rear end of the open-top rear cargo bed 50, the movable bar 12 of the transmission linkage 10 that is located at the front end is caused to move, whereby with the fixed bar 11 that is fixed to the bottom bracket 20 as a fixed and non-movable base, the first and second swing bars 13, 14 are driven to move so that, with the sliding section 18 fixed to the fixed bar 11 and comprising the roller 182, the second swing bar 14 can be pushed out in a more smooth manner and an angular difference induced between the two swing bars 13, 14 during the rotation thereof can guide the top cover 60 to lift upward in a stable manner and the hydraulic (pneumatic) cylinders 40 on the two sides are caused to extend so as to reduce the magnitude of the force applied to open the top cover 60 and to open in a stable manner to a predetermined height and also to provide a support to the top cover after opening. When the top cover 60 is being closed, cushioning is achieved through compression of the hydraulic (pneumatic) cylinder 40 and the cover causes the movable bar 12 of the transmission linkage 10 to close in a direction toward the fixed bar 11 and drives the first and second swing bars 13, 14 to move. With the arrangement of the sliding section 18 that is mounted to the fixed bar 11 and comprises the roller 182, the operation of closing the second swing bar 14 in a direction toward the fixed bar 11 is made smoother. When the top cover 60 is completely closed in a closed condition, the positioning peg 16 formed on the first swing bar 13 is received and positioned in the notch 171 defined in the limiting section 17 of the fixed bar 11 (as shown in FIG. 5) thereby providing an effect of position constraining and making the entire structure more stable.

Further, the support structure of the present invention has a modularized design. All the components can be primarily assembled with the top cover 60 in the factory, allowing a user, after purchasing, to just couple the bottom bracket 20 to an open-top rear cargo bed 50 of a truck, thereby making the installation convenient and efficient. Further, when the support structure is applied to an automobiles of a different modes, it only needs to replace the bottom bracket 20 and the top cover retention seat 30 with ones that are of lengths suitable to such a mode. Thus, the adoptability is enhanced. The capability of management and control of the components is improved and the overall cost is reduced to thereby achieve strong market competition power.

In summary, the present invention can achieve the desired purposes by providing a safer, more stable, and smoother top cover support structure that may have an improved capability of load carrying.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1: An improved top cover support structure of a rear cargo bed of a truck, comprising a transmission linkage, a bottom bracket, a top cover retention seat, and a hydraulic (pneumatic) cylinder, and characterized in that:
the transmission linkage is connected between the rear cargo bed and a top cover to serve as a support structure for opening and closing the cover, the transmission linkage comprising a fixed bar that is mounted to a side of the rear cargo bed, a movable bar mounted to the top cover, and a first swing bar and a second swing bar each having ends respectively and pivotally connected to the fixed bar and the movable bar;
the bottom bracket is mounted to a top edge of an inside surface of a side panel of rear cargo bed to receive the fixed bar of the transmission linkage to attach thereto;
the top cover retention seat is mounted to a bottom of a front end portion of the top cover to receive the movable bar of the transmission linkage to attach thereto; and
the hydraulic (pneumatic) cylinder is pivotally connected to the rear cargo bed and the top cover to support and cushion opening and closing of the top cover;
wherein the fixed bar of the transmission linkage comprises a first protrusion section formed thereon to receive the first swing bar to pivotally connect thereto and a second protrusion section formed thereon to receive the second swing bar to pivotally connect thereto and further comprises a limiting section formed at an end thereof adjacent to the first protrusion section and a sliding section formed thereon at a location adjacent to the second protrusion section;
wherein the limiting section of the fixed bar comprises a notch formed therein, a positioning e being provided at a pivotal joint between the first swing bar and the movable bar so that when the top cover is closed, the positioning peg is received and positioned in the notch of the limiting section;
wherein the sliding section of the fixed bar comprise a seat and a roller, the seat comprising a slot formed therein, the roller being received and retained in the slot the seat being fixed to a surface of the fixed bar;
wherein the fixed bar, the movable bar, and the first swing bar and the second swing bar of the transmission linkage are pivotally jointed by being riveted with rivets and a washer is provided in each of the pivotal joints of the bars; and
wherein the bottom bracket has a transmission linkage assembling surface in which a recess is formed and the fixed bar of the transmission linkage is received and fixed in the recess.

2-6. (canceled)

7: The improved top cover support structure of the rear cargo bed of the truck according to claim 1, wherein the top cover retention seat comprises a transmission linkage assembling surface in which a recess is formed to receive the movable bar of the transmission linkage to fix therein.

8: The improved top cover support structure of the rear cargo bed of the truck according to one of claims 1, wherein the bottom bracket has a transmission linkage assembling surface in which a recess is formed and the fixed bar of the transmission linkage is received and fixed in the recess.
